(19) United States
(12) Patent Application Publication
(10) Pub. No.: US 2011/0317774 A1
(43) Pub. Date: Dec. 29, 2011

(54) SYSTEMS AND METHODS FOR CONTROLLING THE TRANSMISSION OF INDEPENDENT BUT TEMPORALLY RELATED ELEMENTARY VIDEO STREAMS

(75) Inventor: Ray E. Lehtiniemi, Calgary (CA)

(73) Assignee: Worldplay (Barbados) Inc., Bridgetown (BB)

(21) Appl. No.: 12/822,879

(22) Filed: Jun. 24, 2010

(51) Int. Cl. H04N 7/12

(52) U.S. Cl. 375/240.28; 375/E07.026

(57) ABSTRACT

By multiplexing a plurality of elementary video streams it is possible to combine the streams so that they appear as a single stream to existing transportation protocols. In one embodiment, the Carrier stream retains its timestamp and resolution information and metadata is added that allows for the reconstruction of the missing timestamps and/or resolution information for each frame of the Detail stream. In this manner, the transportation protocol is unaware that a second video stream has been hidden in the first stream and thus two video streams are transported concurrently using a protocol established for a single stream.

### CROSS-REFERENCE TO RELATED APPLICATIONS

This application is related to commonly owned patent application SYSTEMS AND METHODS FOR HIGHLY EFFICIENT VIDEO COMPRESSION USING SELECTIVE RETENTION OF RELEVANT VISUAL DETAIL, U.S. patent application Ser. No. 12/176,374, filed on Jul. 19, 2008, Attorney Docket No. 54729/P012US/10808779; SYSTEMS AND METHODS FOR DEBLOCKING SEQUENTIAL IMAGES BY DETERMINING PIXEL INTENSITIES BASED ON LOCAL STATISTICAL MEASURES, U.S. patent application Ser. No. 12/333,708, filed on Dec. 12, 2008, Attorney Docket No. 54729/P013US/10808780; VIDEO DECODER, U.S. patent application Ser. No. 12/638,703, filed on Dec. 15, 2009, Attorney Docket No. 54729/P015US/11000742 and concurrently filed, co-pending, commonly owned patent applications SYSTEMS AND METHODS FOR HIGHLY EFFICIENT COMPRESSION OF VIDEO, U.S. patent application Ser. No. ______, Attorney Docket No. 54729/P016US/11000746; A METHOD FOR DOWNSAMPLING IMAGES, U.S. patent application Ser. No. ______, Attorney Docket No. 54729/P017US/11000747; DECODER FOR MULTIPLE INDEPENDENT VIDEO STREAM DECODING, U.S. patent application Ser. No. ______, Attorney Docket No. 54729/P018US/11000748; SYSTEMS AND METHODS FOR ADAPTING VIDEO DATA TRANSMISSIONS TO COMMUNICATION NETWORK BANDWIDTH VARIATIONS, U.S. patent application Ser. No. ______, Attorney Docket No. 54729/P020US/11000750; and SYSTEM AND METHOD FOR MASS DISTRIBUTION OF HIGH QUALITY VIDEO, U.S. patent application Ser. No. ______, Attorney Docket No. 54729/P021US/11000751 all of the above-referenced applications are hereby incorporated by reference herein.

### TECHNICAL FIELD

This disclosure relates to transmission formats for video transmission and more particularly to systems and methods for controlling the transmission of independent but temporally related elementary video streams.

### BACKGROUND OF THE INVENTION

For reasons discussed in the above entitled co-pending application titled SYSTEMS AND METHODS FOR HIGHLY EFFICIENT COMPRESSION OF VIDEO, situations exist where for high compression efficiency the video stream is divided into a Detail portion and a Carrier portion which, while locked together temporally are actually independent streams compressed separately. For discussion purposes herein, the output of the encoding process is an elementary stream and is a detailed series of bits representing the output of the encoder. In the prior art, there would be one elementary video stream for the video and one elementary audio stream for the audio. In the high compression encoder circuit discussed above, there are two elementary video streams which present challenges to transportation of the streams using existing formats.

One challenge is to mesh the two elementary video streams into a single stream so as to be able to leverage existing video production systems and transports. This meshing must be accomplished in a manner to avoid the necessity of working on a case by case basis to modify existing supporting tools and equipment. In some situations, such as MPEG-4, the file container allows a second video stream to be carried in the existing container format.

However, existing video production systems have a fairly structured framework as to how video and audio pipelines are laid out. In that structure there is only room for one video decoder stream. The problem with trying to put two video streams together stems primarily from the way video is packetized. When a frame (a series of pixels forming one picture) of raw video arrives there is certain information about that frame that must be stored with that portion of data. This information is, for example, a timestamp indicating when the associated frame will be presented and a resolution, i.e., the size of the stream of video associated with the frame.

Because of the asynchronous nature of the high compression encoding process, there are different sets of information pertaining to the different timestamps and different resolutions, as well as many other differences of required information between the Carrier and Detail videos. For the most part, the existing transportation formats do not have provisions for concurrently handling dual informational channels.

### BRIEF SUMMARY OF THE INVENTION

By multiplexing a plurality of elementary video streams it is possible to combine the streams so that they appear as a single stream to existing transportation protocols. In one embodiment, the Carrier stream retains its timestamp and resolution information and metadata is added that allows for the reconstruction of the missing timestamps and/or resolution information for each frame of the Detail stream. In this manner, the transportation protocol is unaware that a second video stream has been hidden in the first stream and thus two video streams are transported concurrently using a protocol established for a single stream.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows data configuration pertaining to the video stream as a whole;

FIG. 2 shows pixel data pertaining to the video stream portion that applies to individual frames of video;

FIG. 3 shows one embodiment of a process of constructing an access unit of video;

FIG. 4 shows one embodiment for compressing source video into transmission frames for delivery to a remote location via a network;

FIG. 5 shows one embodiment of encryption; and

FIG. 6 shows one embodiment of parameter gathering for constructing the Configuration frames.

### GENERAL DESCRIPTION

Before beginning the Detailed Description some terms may be handy to have in mind.

GOP—Group of pictures—a portion of the video stream starting with an I frame which can be seeked to and immediately decoded.

H.264—Standard video compression format used for each of the two video streams which make up a dual temporally-related video stream.

MPEG4—Standard video file format used to hold dual compressed video streams.

NAL—Network Abstraction Layer—concept defined by H.264 to hold a discrete portion of an H.264 video stream, usually a single frame of video.

### DETAILED DESCRIPTION OF THE INVENTION

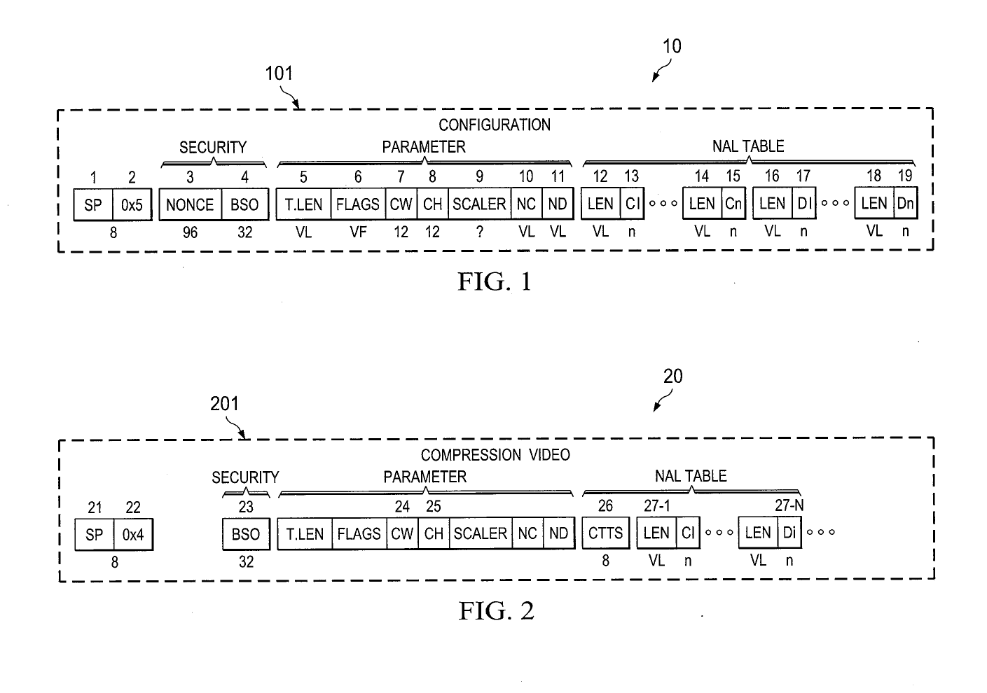

FIG. 1 shows data Configuration frame 101 pertaining to the video stream as a whole. In some situations, there will be a single Configuration frame for an entire movie or for a large portion of a movie. The data in these configuration data frames can be thought of as global control data for controlling the decompression of video data contained in a plurality of related Video data frames. For live broadcasts, there may be many Configuration frames if the parameters of the encoding change from time to time. Advantage is taken of existing transmission protocols so that the Carrier and Detail stream can both be carried where only a single stream was carried previously. In these existing protocols a Network Abstraction Layer (NAL) unit contains, for example, macro block information for a coded video frame. In some situations, the NAL might contain supplementary enhancement information that describes who authored the video, and other housekeeping information. There are Configuration NAL units that apply globally to the stream and Video NAL units that carry the actual video information. In some situations there be many NAL units that are required to fully describe a decoded picture and an access unit is the collection of NAL units which are required to describe one picture.

As shown in FIG. 1, the NAL units are bundled as if they are for the Carrier video stream. As will be discussed, the NAL units for the Detail are then added to the Carrier stream. Configuration information for the Carrier and Detail is shown at locations 12 through 19, inclusive. The length of the data (LEN) to follow is contained in location 12. Location 13C₁ contains the configuration information for the first pixel set (C₁) of the Carrier stream and position 15 contains the Carrier stream's nth pixel configuration. Similarly, the configuration information for the Detail stream pixels run from location 17 through 19.

Preceding the pixel specific information at positions 5 through 11 are parameters that describe parts of the high compression process that are required to decode the video. This portion also contains how many NAL units there are in locations 12 through 19. Locations 3 and 4 contain security information. If encryption is used, the keys and other data would be at these locations. Locations 1 and 2 are header fields which identify this stream as a high compression stream. Note that the numbers below the locations show the number of bits in this embodiment with VL meaning variable length and n representing whatever number of bits there happens to be in the data for a particular segment. As discussed above, the Configuration access unit contains the overall stream information, and the Video access unit contains actual pixel data NAL units. Note that for convenience, the two access units (frames) are shown with different numbers for the locations. This is for convenience for discussion and in reality they are the same locations.

FIG. 2 shows pixel data 201 pertaining to the video stream portion that applies to individual frames of video. The parameter field is basically the same as shown in FIG. 1 except that fields 24 and 25 (corresponding to fields 7 and 8) encodes the width and height, respectively, of the carrier stream. Thus, the width and height of the scaled down Carrier are stored in the metadata thereby telling the decoder what the final decoded size of the video should be. This effectively indicates how big the Carrier is.

Similarly, every access unit stored in the container file must have a timestamp associated with it so that the decoder will know when to display that access unit. Position 26 contains the time offset which can be added or subtracted from the Carrier timestamp in the container to obtain the corresponding time for the “piggyback” Detail pixel frame. This then allows the Carrier and the Detail streams to be transported in a single protocol container while still maintaining different resolutions and timestamps.

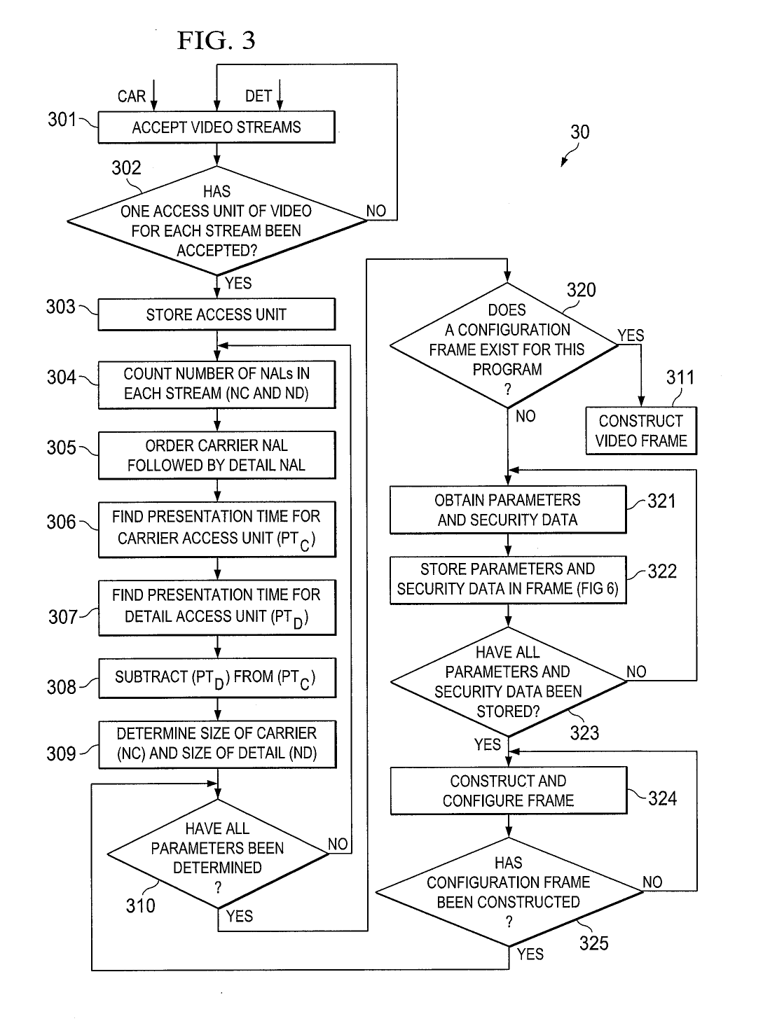

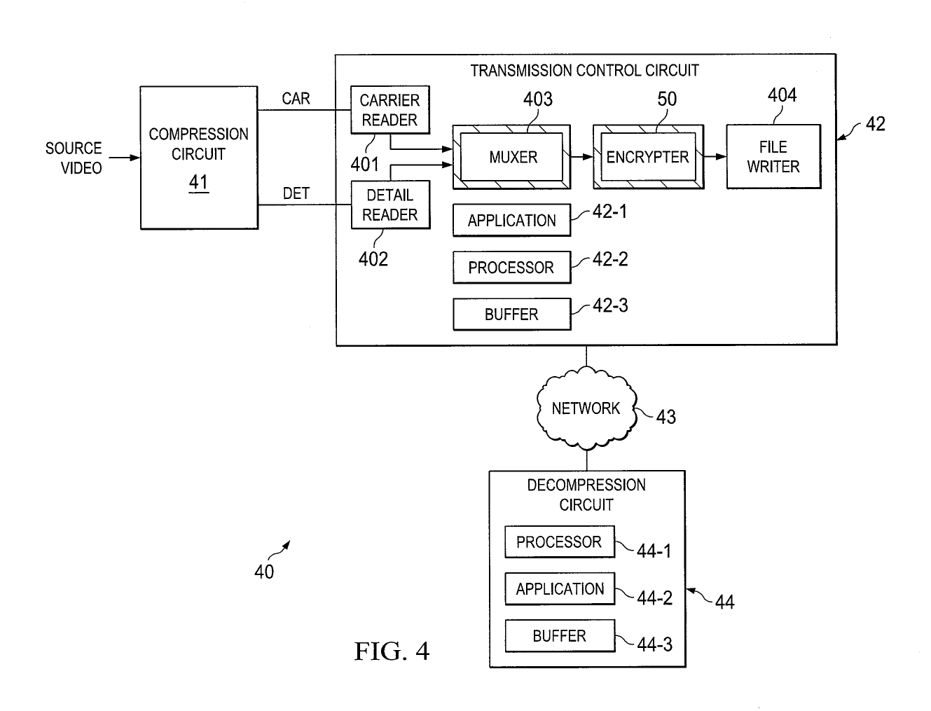

FIG. 3 shows one embodiment 30 of a process of constructing an access unit of video. This process can, in one embodiment, be performed by a processor, such as processor 42 (FIG. 4) working in conjunction with application 403. Process 301 accepts the two (or more if desired) elementary streams, which can be in H.264 format, if desired. Process 302 determines if one access unit worth of video information from each stream has been accepted. If it has then the two access units (one for the Carrier stream and one for the Detail stream) are buffered by process 303, for example, by buffer 404 (FIG. 4). This is all the NAL units require to construct the first frame of codec (compressed composite) video in whatever order it happens to be for each of those Carrier and Detail streams.

Process 304 counts the number of NAL units that are taken up in each of those streams to make that frame of video. The count is called NC for the number of NAL units on the Carrier stream, and called ND for the number of NAL units on the Detail stream. Those counts are then stored in locations 10 and 11 of the Configuration field (FIG. 1). Once the number of NAL units is determined, process 305 orders all the carrier NAL units first, followed by all the detail NAL units, thereby forming the body of the packet.

Next, the system deals with the timestamp issue. Process 306 calculates the presentation time PT_{C} for the Carrier access unit and process 307 calculates the presentation time PT_{D} for the Detail access unit. Next, the frames per second value of the video stream is used to convert this absolute time difference into a relative frame count between the two frames. Process 308 then subtracts PT_{D} from PT_{C} and then stores that difference as CTTS into location 26 (FIG. 2). Note that the presentation time for the carrier is not stored in the SSV2 format, instead, it is stored in the container format into which the SSV2 stream is stored. This solves the problem discussed above pertaining to the fact that the container format has only a single space to store a timestamp for a single frame of video.

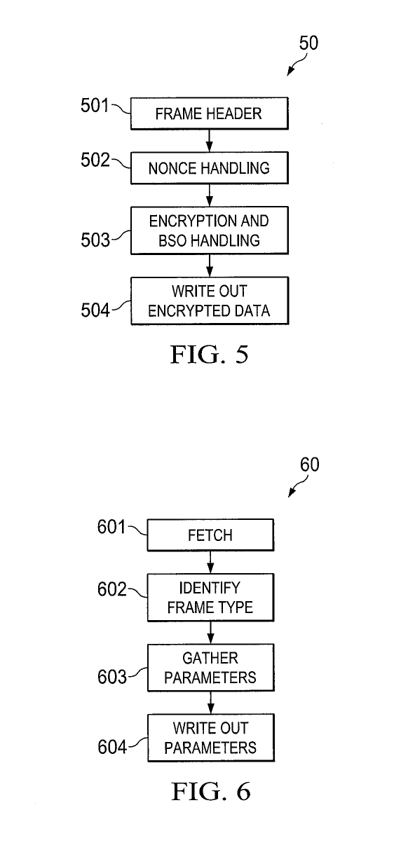

Process 309 determines the size of the Carrier (NC) and the size of the Detail (ND) and these values then go in locations 10 and 11. The values for locations 7 and 8 are known and/or calculated as detailed with respect to FIG. 6. The parameter list structure examines the values which have been stored by process 603 (FIG. 6) to determine if any parameter requires writing out to the video stream. If carrier width/height are present, or if the carrier/detail NAL counts are not equal to 1, then they must be written out to the video stream.

Locations 1 and 21 have two flags each, an S flag and a P flag. The S flag controls input signals indicating whether or not the Access Unit is encrypted. The effect that has is it essentially signals the presence or absence of locations 3, 4 or 23 which contain information used by the decryption process. The P flag controls the presence of the parameter blocks. They are generally always there, but there is the possibility that they might not be.

When process 310 determines that all of the parameters pertaining to the Video frame have been gathered, process 311 constructs the Video frame and writes out all the carrier NAL units and all the detail NAL units in the order they appear in the original H.264 streams. Each NAL unit is preceded by its length LEN (FIGS. 1 and 2) in bytes and positioned locations 27-1 through 27-n (FIG. 2). This prepares the frame for transmission to a remote location in accordance with the desired protocol. In this way, more than one video stream can be packed transparently into a protocol designed for a single video stream.

Process 320 determines if there is a Configuration frame already constructed for this program (or for the settings necessary for this particular frame). If so, then process 31 constructs the Video frame. If not, then process 321 obtains the necessary protocols as shown and discussed with respect to FIG. 6. Process 322 stores the global parameters pertaining to this program. When process 323 determines that all parameters and security codes have been obtained, process 324 constructs the Configuration frame.

If desired, the Access Units can be encrypted, for example, using 128-bit AES encryption. In such a situation, there would be a static shared key between the encoder and all the decoders. In such a situation, the decoder key is compiled into the net list of the decoder FPGA image.

In order to allow random access to the encrypted stream, the AES block cipher should be operated in counter mode, such that the 128-bit initialization vector for the AES algorithm is split into two sub-fields. In one embodiment, these sub-fields are locations 3 and 4 (23) of the configuration (video) frames. These fields are called NONCE and byte stream offset (BSO). The BSO is the offset of the start of the packet within the entire encrypted data. This then provides a unique key for every encrypted byte of data since every byte offset is different. The NONCE is created by using the current time the video is encrypted in combination with other factors to yield a one-time unique code.

The NONCE thus can be used for customer fencing since it can also be used as a customer ID. This NONCE value then can be looked at in the field to compare against a table of customer IDs that this decoder belongs to. In one embodiment, there would be a table of customer IDs stored on the decoders. these customer IDs would form a piece of the nonce, and the incoming nonce would be split apart into it's constituent parts and the customer ID extracted, and compared against this table. If that customer ID in the NONCE doesn't match the customer that this decoder belongs to then it can't be decrypted. This then allows for the encoding of content received under one agreement from one supplier and insures that only customers of that supplier can decode the data.

The Video frame (FIG. 2) contains the bulk pixel data that makes up the coded video and is streamed in real time. That data can be sent using either a reliable transmission medium, such as TCP, or an unreliable medium, such as UDP.

The Configuration frame (FIG. 1) contains information that is quantitatively more important than the Video frame since a single Configuration frame might be required to decode all of the Video frames, perhaps for the entire movie or program. So it is important for the entire Configuration frame to arrive at the proper destination without loss or corruption. In some situations, the Configuration frame can be sent out of band and often will be sent with repetition. So in the case of a file container, such as an MPEG file container, all of the Video frames would be stored in the bulk of the MDAT container in that case. However, the Container frame(s) would be stored in the metadata portion of the file. Thus, in situations where the container is streamed across a network, such as the Internet, it is taken out and sent across a reliable TCP connection setup protocol. Thus, the Container frame would be transmitted in a first mode over a reliable medium, such as TCP, and then the bulk video data might get pushed out in a different mode over an unreliable UDP medium. The reason that UDP is acceptable for the Video frames is that if some information is lost the picture is still usable, albeit with a possible slight loss of fidelity. If the Configuration frame is lost or corrupted the Video frames that follow will not be decoded properly, if at all.

FIG. 4 shows one embodiment 40 for compressing source video into transmission frames for delivery to a remote location via a network. In the embodiment shown, the source video is compressed into a Carrier stream and a Detail stream, for example by procedure detailed in above-identified co-pending patent application entitled SYSTEMS AND METHODS FOR HIGHLY EFFICIENT COMPRESSION OF VIDEO. The transportation protocols discussed herein can be, for example, formatted by transmission control circuit 42 under control of application 42-1 running on processor 42-2 with the data stored from time to time in buffers 42-3. The transmission frames can be delivered to destinations using any network, including packet network 43 and can be decoded by a decompression circuit at the remote destination. One such decoding circuit can be, for example, as shown in co-pending patent application entitled DECODER FOR MULTIPLE INDEPENDENT VIDEO STREAM DECODING. The transportation protocols can be used by an application, such as application 44-2 in processor 44-1 and buffered by buffers 44-3 at decompression circuit 44. The decoding circuit can then decompress the temporally-related compressed video streams and render them into a composite human user viewable set of images. This operation is performed using the timestamp and the timestamp offset to recreate a proper temporal relationship between the video streams. In this manner, the resulting viewable image is of high fidelity. In this context, high fidelity or visual fidelity, is defined as the viewed reconstructed images being perceived by the Human Viewing System (HVS) as a close representation of the source image. Thus, in high fidelity situations the viewer of the decoded (decompressed) video image does not discern differences from the original source image.

Carrier reader 401 is a standard MPEG4 reader which extracts the carrier H.264 elementary stream from the first MPEG4 file container produced by encoder 41. Detail reader 402 is a standard MPEG4 reader which extracts the detail H.264 elementary stream from the second MPEG4 file container produced by encoder 41.

Muxer 403 performs the mux function to combine the carrier and detail elementary streams into an unencrypted elementary stream. Optionally, encryptor 50 (FIG. 5) performs an encryption function to convert the unencrypted video stream into an encrypted stream. File writer 404 is a standard MPEG4 file writer function. This function accepts encrypted access units and writes them into an MPEG4 file container as discussed above.

Note the processors discussed herein can run software code and/or could be designed as firmware or hardware depending upon the situation. Also note that while the above discussion has focused on two video streams, the concepts would apply to more than two video streams and would also apply to other types of data streams having the same temporal relationships therebetween as discussed herein.

FIG. 5 shows one embodiment 50 of encryption which is optional. Process 501 copies blocks of data from the frame. First, locations 1 and 2 (or 21, 22) are copied to the output stream, with location 1 (21) modified to include the S bit set to indicate the stream is now scrambled.

Process 502 performs nonce handling such that if the packet is a Configuration frame, then the nonce value used for the encryption must be written out in location 3. Process 503 handles encryption and BSO such that the BSO value used for the encryption is written in location 4 (23). The rest of the packet is then run through a standard AES-128 encryption function, using a secret 128 bit key and an initialization vector generated from the nonce and BSO, into a temporary buffer. The length of this buffer is added to the current BSO value for use in the next packet to be encrypted.

Process 504 writes out encrypted data to a temporary buffer which is then written out to the output stream.

FIG. 6 shows one embodiment 60 of parameter gathering for constructing the Configuration frames. Process 601 fetches input frames and makes room for the output frame. The next Carrier and Detail video frames are fetched from the two input streams from compression circuit 41 (FIG. 4). As a result, a single output frame is allocated.

Process 602 identifies the type of the output frame. For Configuration frames, the value 0x05 is written to location 2 and for Video frames the value 0x04 is written to location 22. (As discussed above, these are actually the same locations but numbered for clarity of discussion herein). Process 303 gathers the parameters, first by creating an empty parameters list structure in memory. The total number of H.264 NAL units in both the Carrier and Detail streams are written into this structure. If this is a Video frame, and if the Video frame from the Carrier stream is an I-frame, then write the carrier width (CW) and height (CH) into this structure at locations 24 and 25. The reason for this is to allow for the use of different carrier scaling size for each GOP in the Carrier stream.

Process 604 examines the values which have been generated by process 603 and determines if any require writing out to the Video stream. If Carrier width/height are present, or if the carrier/detail NAL counts are not equal to 1, then they must be written out.

The process calculates a flag set for location 6, encoded values for locations 7 through 11, and a total length (T. LEN) for location 5. These values are gathered together into a buffer and written out to the output packet. For Video frames, the same process results in the corresponding locations.

The scaler, if used, for location 9 is either fixed for all the frames or variable as desired. One or more of the flags can be used to tell the decoder to ignore certain streams or to not bother with the offset because there is only one video stream.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of creating temporally-related compressed video streams, said method comprising:
creating a first data frame containing global parameters for controlling decompressing of video data contained in data frames other than said first data frames;
creating a plurality of second data frames, each said created second data frame containing compressed video data pertaining to a first video data stream of said program, each said second data frame having at least one timestamp for indicating when a decompressed rendition of said first data stream video contained in said second data frame is to be presented to a viewer, said decompression of said data in each said second data frame controlled, at least in part, by said parameters contained in a related first data frame; and
creating within each second data frame, in conjunction with said compressed first video data stream additional compressed video data of a second compressed video stream of said program, said additional compressed video data having a temporal relationship with said first video data stream.

2. The method of claim 1 wherein each said second data frame comprises:
means for controlling a time when a decompressed rendition of said second data stream video contained in said second data frame is to be presented to a viewer.

3. The method of claim 2 wherein said controlling means comprises:
at least one timestamp offset from said at least one timestamp.

4. The method of claim 3 further comprising:
delivering a pair of temporally-related compressed video streams to a remote location via a packet network.

5. The method of claim 4 further comprising:
decompressing said temporally-related compressed video streams at said remote location; and
rendering said decompressed temporally related video streams into a composite human user viewable set of images under at least partial control of said timestamp and said timestamp offset to recreate a proper temporal relationship between said video streams to create said image having high fidelity.

6. A system for packaging compressed video data for transportation on a communication network, said system comprising:
a first processor for determining a time offset between a given amount of compressed Carrier video stream and a given amount of said compressed Detail video stream, and
said first processor further operable for packing both said given amounts of said Carrier and Detail streams into a transmission protocol designed for a single video stream such that said packing is transparent to said transmission protocol.

7. The system of claim 6 wherein said packing comprises:
placing said given amount of said Carrier compressed video stream into a first video access unit of said transmission protocol, said video access unit containing a timestamp of said Carrier stream placed in said first video access unit;
concurrently placing said given portion of said Detail compressed video stream into said first access unit; and
adding to said first access unit said determined time offset of said given amount of said Detail stream from said Carrier stream.

8. The system of claim 7 wherein said processor is further operable for creating at least one access unit separate from said first access unit having global parameters pertaining to a plurality of video access units.

9. The system of claim 8 further comprising:
a second processor at a location remote from said first processor operable for decompressing compressed video streams within said video access units in accordance with said global parameters; and wherein said second processor is further operable for rendering said decompressed streams into a composite human user viewable set of images under at least partial control of said timestamp and said timestamp offset to recreate a proper temporal relationship between said video streams to create said image having high fidelity.

10. The system of claim 9 further comprising:
buffers for storing said global parameters obtained from a configuration frame, and
means for separating a single frame of compressed video into a decompressed Carrier stream and a decompressed Detail stream; and
means for combining said decompressed Carrier and Detail streams to create said proper temporal relationship.

11. A transmission control circuit comprising:
means for accepting temporally related Carrier and Detail compressed video streams;
means for accepting global parameters pertaining to data necessary for properly decompressing said Carrier and Detail compressed video streams,
means for calculating a time differential between said temporally related compressed video streams; and
means for packaging accepted ones of said global parameters as well as both said Carrier and Detail compressed data streams into a protocol designed for transporting a single compressed data stream across a network.

12. The system of claim 11 wherein said protocol requires said global parameters to be contained in a Configuration frame and said single compressed video stream to be contained in a series of Video frames transported separately from said Configuration frame.

13. The system of claim 12 wherein said time difference for each Video frame is stored as a time offset of said Detail from said Carrier compressed video streams.

14. A transmission control circuit comprising:
a processor for controlling acceptance of temporally related Carrier and Detail compressed video streams;
said processor further operable for controlling acceptance of global parameters pertaining to data necessary for properly decompressing said Carrier and Detail compressed video streams and for calculating a time differential between said temporally related compressed video streams;
and for packaging accepted ones of said global parameters as well as both said Carrier and Detail compressed data streams into a protocol designed for transporting a single compressed data stream across a network.

15. The circuit of claim 14 wherein said protocol requires said global parameters to be contained in a Configuration frame and said single compressed video stream to be contained in a series of Video frames transported separately from said Configuration frame.

16. The circuit of claim 15 wherein said time difference for each Video frame is stored as a time offset of said Detail from said Carrier compressed video streams.

17. The method of packaging a plurality of temporally related compressed video streams, said method comprising:
accepting temporally related Carrier and Detail compressed video streams;
accepting global parameters pertaining to data necessary for properly decompressing said Carrier and Detail compressed video streams,
calculating a time differential between said temporally related compressed video streams; and
packaging accepted ones of said global parameters as well as both said Carrier and Detail compressed data streams into a protocol designed for transporting a single compressed data stream across a network.

18. The method of claim 17 wherein said protocol requires said global parameters to be contained in a Configuration frame and said single compressed video stream to be contained in a series of Video frames transported separately from said Configuration frame.

19. The method of claim 18 wherein said time difference for each Video frame is stored as a time offset of said Detail from said Carrier compressed video streams.

20. The method of claim 19 further comprising:
communicating Configuration frames to a destination location using a highly reliable transmission mode; and
communicating Video frames to said destination location using any transmission mode.
